(19) United States
(12) Patent Application Publication
(10) Pub. No.: US 2026/0242272 A1
(43) Pub. Date: Aug. 20, 2026

(54) PRODUCTION METHOD FOR GLASS PREFORM AND PRODUCTION APPARATUS FOR GLASS PREFORM

(71) Applicant: SUMITOMO ELECTRIC INDUSTRIES, LTD., Osaka (JP)

(72) Inventor: Tatsuro HASEGAWA, Osaka (JP)

(21) Appl. No.: 19/533,751

(22) Filed: Feb. 9, 2026

(30) Foreign Application Priority Data
Feb. 14, 2025 (JP) 2025-022631

(51) Int. Cl. C03B 37/012; C03B 37/014; C03B 37/018

(52) U.S. Cl. CPC C03B 37/01211; C03B 37/0146; C03B 37/01815; C03B 37/01846

(57) ABSTRACT

A production method for a glass preform in a production apparatus. The production apparatus includes a main chamber configured to produce the glass preform in a state where a glass fine particle deposit is accommodated in the main chamber, and a preliminary chamber communicating with the main chamber, the preliminary chamber being formed such that the glass fine particle deposit and the glass preform are allowed to be put in and taken out. A furnace core tube is accommodated inside the main chamber, the furnace core tube being configured to produce the glass preform in a state where the glass fine particle deposit is accommodated in the furnace core tube. The production method includes a production step of producing the glass preform by consolidating the glass fine particle deposit in the furnace core tube while introducing corrosive gas into the furnace core tube.

### CROSS-REFERENCE TO RELATED APPLICATIONS

This application is based on and claims priority under 35 USC 119 from Japanese Patent Application No. 2025-022631 filed on February 14, 2025, the entire content of which is incorporated herein by reference.

### TECHNICAL FIELD

The present disclosure relates to a production method for a glass preform and a production apparatus for a glass preform.

### BACKGROUND ART

JP2004-142976A discloses that corrosive gas such as fluorine gas is introduced into a furnace core tube in a production step of a glass preform.

### SUMMARY OF INVENTION

According to an aspect of the present disclosure, there is provided a production method for a glass preform in a production apparatus,

the production apparatus including:

a main chamber configured to produce the glass preform in a state where a glass fine particle deposit is accommodated in the main chamber; and

a preliminary chamber communicating with the main chamber, the preliminary chamber being formed such that the glass fine particle deposit and the glass preform are allowed to be put in and taken out,

in which a furnace core tube is accommodated inside the main chamber, the furnace core tube being configured to produce the glass preform in a state where the glass fine particle deposit is accommodated in the furnace core tube,

the production method including:

a production step of producing the glass preform by consolidating the glass fine particle deposit in the furnace core tube while introducing corrosive gas into the furnace core tube;

a gas introduction step of introducing gas into the preliminary chamber after the production step; and

a gas discharge step of discharging gas from at least one of the preliminary chamber and the main chamber after the production step,

in which the gas introduction step is started before end of the gas discharge step.

### BRIEF DESCRIPTION OF DRAWINGS

Exemplary embodiment(s) of the present invention will be described in detail based on the following figures, wherein:

FIG. 1 illustrates a production apparatus for a glass preform according to a first embodiment and a second embodiment;

FIG. 2 illustrates a production apparatus for a glass preform according to a third embodiment; and

FIG. 3 illustrates a production apparatus for a glass preform according to a fourth embodiment.

### DESCRIPTION OF EMBODIMENTS

In a production apparatus for a glass preform, a furnace core tube capable of accommodating a glass preform and a glass fine particle deposit for producing the glass preform is accommodated therein, and a preliminary chamber for accommodating the glass fine particle deposit and the produced glass preform is provided separately from a main chamber in which the glass preform is produced. Since a worker enters and exits the preliminary chamber for work, it is desirable to reduce the concentration of the corrosive gas in the preliminary chamber.

An object of the present disclosure is to provide a production method for a glass preform and a production apparatus therefor that can reduce a concentration of corrosive gas in a preliminary chamber.

According to the present disclosure, it is possible to provide a production method for a glass preform and a production apparatus therefor that can reduce the concentration of the corrosive gas in the preliminary chamber.

### Description of Embodiments of Present Disclosure

First, embodiments of the present disclosure will be listed and described. (1) A production method for a glass preform according to an aspect of the present disclosure is a production method for the glass preform in a production apparatus, the production apparatus including: a main chamber configured to produce the glass preform in a state where a glass fine particle deposit is accommodated in the main chamber; a preliminary chamber communicating with the main chamber, and the preliminary chamber being formed such that the glass fine particle deposit and the glass preform are allowed to be put in and taken out, in which a furnace core tube is accommodated inside the main chamber, the furnace core tube being configured to produce the glass preform in a state where the glass fine particle deposit is accommodated in the furnace core tube, the production method including: a production step of producing the glass preform by consolidating the glass fine particle deposit in the furnace core tube while introducing corrosive gas into the furnace core tube; a gas introduction step of introducing gas into the preliminary chamber after the production step; and a gas discharge step of discharging gas from at least one of the preliminary chamber and the main chamber after the production step, in which the gas introduction step is started before end of the gas discharge step.

According to the production method for a glass preform described above, the gas introduction step of introducing the gas into the preliminary chamber and the gas discharge step of discharging the gas from at least one of the preliminary chamber and the main chamber are performed after the production step. Therefore, even when the corrosive gas introduced into the furnace core tube leaks into the main chamber outside the furnace core tube during the production of the glass preform, the gas introduced into the preliminary chamber is discharged together with the corrosive gas, so that the concentration of the corrosive gas in the preliminary chamber can be reduced.

(2) In the production method for a glass preform according to (1), the gas discharge step may be a step of discharging gas from the preliminary chamber.

According to the production method for a glass preform described above, since the gas is discharged from the preliminary chamber, the corrosive gas is less likely to remain in the preliminary chamber in which the concentration of the corrosive gas is desired to be reduced.

(3) In the production method for a glass preform according to (2), the gas introduction step and the gas discharge step may be alternately performed at least once.

According to the production method for a glass preform described above, since the gas introduction step and the gas discharge step are alternately performed at least once, no gas is introduced during the gas discharge step, and thus a complicated control is not required for the gas introduction step and the gas discharge step. In addition, a degree of freedom is improved in locations where the gas introduction port and the gas discharge port are formed.

(4) In the production method for a glass preform according to (2), the gas introduction step and the gas discharge step may be performed simultaneously.

According to the production method for a glass preform described above, since the gas introduction step and the gas discharge step are performed simultaneously, the corrosive gas is less likely to remain in a discharge pipe that discharges the gas in the gas discharge step. This makes it difficult for the corrosive gas to flow from the discharge pipe to the preliminary chamber.

(5) In the production method for a glass preform according to any one of (1) to (4), the production apparatus may include a gate valve configured to separate the main chamber and the preliminary chamber, and the gas introduction step and the gas discharge step may be performed in a state where the main chamber and the preliminary chamber are separated from each other by the gate valve.

According to the production method for a glass preform described above, since the main chamber and the preliminary chamber are separated by the gate valve, the corrosive gas is less likely to flow from the main chamber to the preliminary chamber during the gas introduction step and the gas discharge step.

(6) In the production method for a glass preform according to any one of (1) to (5), the production apparatus may include a gate valve configured to separate the main chamber and the preliminary chamber, and the gas introduction step and the gas discharge step may be performed in a state where the main chamber and the preliminary chamber communicate with each other by the gate valve.

According to the production method for a glass preform described above, since the main chamber and the preliminary chamber are not separated by the gate valve, the corrosive gas is less likely to remain in the main chamber. Accordingly, even when the gate valve needs to be opened during work, the concentration of the corrosive gas in the preliminary chamber is maintained low.

(7) In the production method for a glass preform according to (6), in the gas discharge step, the gas may be discharged from the preliminary chamber and the main chamber.

According to the production method for a glass preform described above, since the gas is discharged from both the preliminary chamber and the main chamber in a state in which the main chamber and the preliminary chamber are not separated by the gate valve, the concentration of corrosive gas in the main chamber and the preliminary chamber can be reduced.

(8) In the production method for a glass preform according to (6), the gas introduction step and the gas discharge step may be performed simultaneously, and the gas discharge step may be a step of discharging gas from the main chamber.

According to the production method for a glass preform described above, a gas flow is formed in which the gas introduced into the preliminary chamber in the gas introduction step flows into the main chamber and is discharged in the gas discharge step. This makes it difficult for the corrosive gas to flow from the main chamber to the preliminary chamber. Accordingly, the concentration of the corrosive gas in the preliminary chamber can be reduced.

(9) In the production method for a glass preform according to any one of (1) to (8), the gas introduced in the gas introduction step may be inert gas.

According to the above production method, since the inert gas is introduced in the gas introduction step, the inert gas hardly reacts with the glass preform even in a high-temperature environment. Accordingly, since the gas introduction step can be performed immediately after the production step of the glass preform is completed, the glass preform can be efficiently produced.

(10) A production apparatus for a glass preform according to an aspect of the present disclosure includes: a main chamber configured to produce the glass preform in a state where a glass fine particle deposit is accommodated in the main chamber; a preliminary chamber communicating with the main chamber, the preliminary chamber being formed such that the glass fine particle deposit and the glass preform are allowed to be put in and taken out; and a furnace core tube accommodated inside the main chamber, and the furnace core tube being configured to produce the glass preform in a state where the glass fine particle deposit is accommodated in the furnace core tube, in which a corrosive gas introduction port for introducing corrosive gas during consolidating of the glass fine particle deposit is formed in the furnace core tube, a gas introduction port for introducing inert gas after production of the glass preform is formed in the preliminary chamber, and a gas discharge port for discharging gas after production of the glass preform is formed in either the main chamber or the preliminary chamber.

According to the production apparatus for a glass preform having the above configuration, after the production step, gas can be introduced into the preliminary chamber and discharged from at least one of the preliminary chamber and the main chamber. Therefore, even when the corrosive gas introduced into the furnace core tube leaks during the production of the glass preform, the inert gas introduced into the preliminary chamber is discharged together with the corrosive gas, so that the concentration of the corrosive gas in the preliminary chamber can be reduced.

### Details of Embodiments of Present Disclosure

Specific examples of a production apparatus for a glass preform and a production method therefor according to embodiments of the present disclosure will be described below with reference to the drawings. The present disclosure is not limited to these exemplifications, but is indicated by the scope of claims, and is intended to include all changes within a scope and meaning equivalent to the scope of claims.

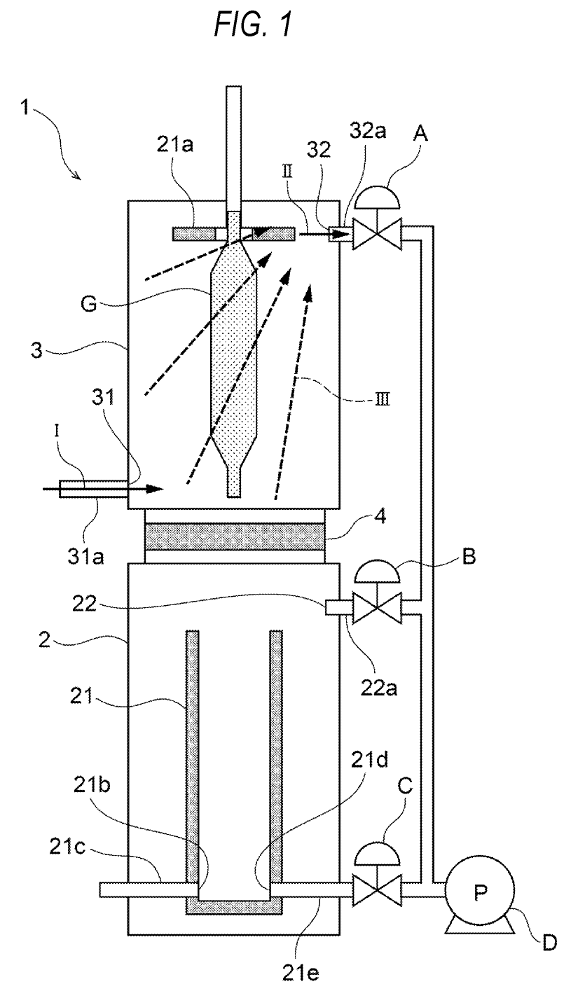

FIG. 1 illustrates a production apparatus 1 for a glass preform G according to a first embodiment. The production apparatus 1 for a glass preform heats a glass fine particle deposit to produce the glass preform G. The production apparatus 1 includes a main chamber 2 and a preliminary chamber 3.

In the main chamber 2, the glass preform G can be produced in a state where the glass fine particle deposit is accommodated in the main chamber 2. Inside the main chamber 2, a furnace core tube 21 for producing the glass preform G in a state where the glass fine particle deposit accommodated in the furnace core tube 21 is accommodated. A lid portion 21a can be provided above the furnace core tube 21. The lid portion 21a is configured to close an upper portion of the furnace core tube 21 during the production of the glass preform G. A corrosive gas introduction port 21b is formed in the furnace core tube 21. A corrosive gas introduction pipe 21c extends from the corrosive gas introduction port 21b toward the outside of the main chamber 2. The corrosive gas introduction port 21b is formed to introduce corrosive gas during consolidating of the glass fine particle deposit. The corrosive gas is, for example, fluoride gas.

The preliminary chamber 3 is formed such that the glass fine particle deposit and the glass preform G are allow to be put in and taken out. The preliminary chamber 3 is provided above the main chamber 2. A preliminary chamber gas introduction port 31 is formed in the preliminary chamber 3. The preliminary chamber gas introduction port 31 is formed in a lower portion of a side surface of the preliminary chamber 3. The preliminary chamber gas introduction port 31 is provided with a preliminary chamber gas introduction pipe 31a. The preliminary chamber gas introduction pipe 31a extends to the outside of the preliminary chamber 3. The preliminary chamber gas introduction port 31 is formed to introduce inert gas after the glass preform G is produced. The preliminary chamber 3 is provided with a door (not illustrated) through which a worker or the glass fine particle deposit and the glass preform G can be put in and taken out.

Either the main chamber 2 or the preliminary chamber 3 is formed with a gas discharge port for discharging gas therein after the glass preform G is produced. The gas discharge port of the present embodiment includes a furnace core tube discharge port 21d formed in the furnace core tube 21, a main chamber discharge port 22 formed in the main chamber 2, and a preliminary chamber gas discharge port 32 formed in the preliminary chamber 3.

The main chamber discharge port 22 is provided with a main chamber discharge pipe 22a. The main chamber discharge pipe 22a extends to the outside of the main chamber 2. A furnace core tube discharge pipe 21e extends from the furnace core tube discharge port 21d to the outside of the furnace core tube 21 and the main chamber 2.

The preliminary chamber gas discharge port 32 is provided with a preliminary chamber gas discharge pipe 32a. The preliminary chamber gas discharge pipe 32a extends to the outside of the preliminary chamber 3. The preliminary chamber gas discharge port 32 is formed to discharge the gas inside the preliminary chamber 3 after the glass preform G is produced. In the present embodiment, the preliminary chamber gas discharge port 32 is formed in an upper portion of the side surface of the preliminary chamber 3.

The preliminary chamber gas discharge pipe 32a, the main chamber discharge pipe 22a, and the furnace core tube discharge pipe 21e are provided with a first flow rate regulator A, a second flow rate regulator B, and a third flow rate regulator C, respectively. The first flow rate regulator A, the second flow rate regulator B, and the third flow rate regulator C can regulate a flow rate of the gas discharged in the preliminary chamber gas discharge pipe 32a, the main chamber discharge pipe 22a, and the furnace core tube discharge pipe 21e, respectively. The furnace core tube discharge pipe 21e, the main chamber discharge pipe 22a, and the preliminary chamber gas discharge pipe 32a are connected to a suction pump D. By the operation of the suction pump D, gas can be sucked through the furnace core tube discharge pipe 21e, the main chamber discharge pipe 22a, and the preliminary chamber gas discharge pipe 32a.

The production apparatus 1 includes a gate valve 4 configured to separate the main chamber 2 and the preliminary chamber 3. FIG. 1 illustrates a state in which the gate valve 4 is closed and the main chamber 2 and the preliminary chamber 3 are isolated from each other, but the gate valve 4 is opened during the production of the glass preform G, and in this case, the main chamber 2 and the preliminary chamber 3 communicate with each other.

Next, a production method for the glass preform G according to the first embodiment will be described. The production method for the glass preform G includes a production step, a gas introduction step, and a gas discharge step. The production step is a step of producing the glass preform G by consolidating the glass fine particle deposit in the furnace core tube 21 while introducing the corrosive gas into the furnace core tube 21. During the production step, the glass preform G is in the main chamber 2, and the gate valve 4 is open. When the production step ends, the glass preform G is pulled up and moved to the preliminary chamber 3, and the gate valve 4 is closed. The gas introduction step and the gas discharge step are performed with the gate valve 4 closed. During the production step, the first flow rate regulator A and the second flow rate regulator B are closed, and the third flow rate regulator C is always opened.

The gas introduction step is a step of introducing the gas into the preliminary chamber 3 from the preliminary chamber gas introduction port 31 after the production step. The gas introduced in the gas introduction step is preferably inert gas such as nitrogen (N2) or helium (He).

The gas discharge step is a step of discharging gas from at least one of the preliminary chamber 3 and the main chamber 2. In the first embodiment, since the preliminary chamber gas discharge port 32 is provided in the preliminary chamber 3, the gas is discharged from the preliminary chamber 3 in the gas discharge step.

The gas introduction step is started before the end of the gas discharge step. The gas introduction step and the gas discharge step are preferably performed with the gate valve 4 closed. In the present embodiment, the gas introduction step and the gas discharge step are started after the gate valve 4 is closed.

In the first embodiment, the gas introduction step and the gas discharge step are performed simultaneously. In the gas introduction step, the gas is introduced into the preliminary chamber 3 (an arrow I). In the gas discharge step, the first flow rate regulator A is opened, and the discharge of the gas in the preliminary chamber 3 is started (an arrow II). In the gas introduction step and the gas discharge step, the first flow rate regulator A is always opened even during the gas introduction step. By performing this simultaneously, a flow of air from the preliminary chamber gas introduction port 31 toward the preliminary chamber gas discharge port 32 is formed inside the preliminary chamber 3 as indicated by a dashed arrow III. Therefore, the air inside the preliminary chamber 3 is easily discharged from the preliminary chamber gas discharge port 32.

In the gas introduction step and the gas discharge step according to the first embodiment, the second flow rate regulator B and the third flow rate regulator C may be opened or closed.

In the production step, the lid portion 21a is attached to the furnace core tube 21, but the corrosive gas may leak out of the glass fine particle deposit and the glass preform G from between a support rod and the lid portion 21a. For safe work of the worker, it is important to reduce a concentration of the corrosive gas in the preliminary chamber 3.

According to the production apparatus 1 for the glass preform G and the production method therefor of the present embodiment, the gas introduction step of introducing the gas into the preliminary chamber 3 and the gas discharge step of discharging the gas from at least one of the preliminary chamber 3 and the main chamber 2 are performed after the production step. Therefore, even when the corrosive gas introduced into the furnace core tube 21 during the production of the glass preform G leaks into the main chamber 2 outside the furnace core tube 21 and is mixed into the preliminary chamber 3, the corrosive gas is discharged together with the gas introduced into the preliminary chamber 3, so that the concentration of the corrosive gas in the preliminary chamber 3 can be reduced.

According to the production method for the glass preform G of the present embodiment, since the gas is discharged from the preliminary chamber 3, the corrosive gas is less likely to remain in the preliminary chamber 3 in which the concentration of the corrosive gas is desired to be reduced.

According to the production method for the glass preform G of the present embodiment, since the gas introduction step and the gas discharge step are simultaneously performed, the corrosive gas is less likely to remain in the preliminary chamber gas discharge pipe 32a that discharges the gas in the gas discharge step.

According to the production method for the glass preform G of the present embodiment, since the main chamber 2 and the preliminary chamber 3 are separated by the gate valve 4, the corrosive gas is less likely to flow from the main chamber 2 to the preliminary chamber 3 during the gas introduction step and the gas discharge step.

According to the production method for the glass preform G of the present embodiment, since the inert gas is introduced in the gas introduction step, the introduced gas is less likely to react with the glass preform G even in a high-temperature environment such as in the vicinity of the glass preform G immediately after production. Accordingly, since the gas introduction step can be performed immediately after the production step of the glass preform G ends, the glass preform G can be efficiently produced.

In the first embodiment, it is desirable that the preliminary chamber gas introduction port 31 and the preliminary chamber gas discharge port 32 are provided on opposite surfaces of the preliminary chamber 3 and at different heights. Accordingly, since the gas introduced from the preliminary chamber gas introduction port 31 flows through a wide range of the preliminary chamber 3 and is discharged from the preliminary chamber gas discharge port 32, the corrosive gas in a wide range is easily discharged from the preliminary chamber 3.

Next, a production method for the glass preform G according to the second embodiment will be described. Since the production apparatus 1 is the same as that of the first embodiment, the description thereof will be omitted.

Since the production step of the second embodiment is not different from the production step of the first embodiment, the description thereof will be omitted.

In the production method for the glass preform G according to the second embodiment, the gas introduction step and the gas discharge step are alternately performed at least once. First, as illustrated in FIG. 1, in a state in which the first flow rate regulator A is closed, the gas is introduced into the preliminary chamber 3 in the gas introduction step (the arrow I). Next, after the introduction of the gas is stopped, the first flow rate regulator A is opened, and the gas discharge step is started (the arrow II). This cycle is alternately repeated at least once.

In the gas introduction step and the gas discharge step according to the second embodiment, the second flow rate regulator B and the third flow rate regulator C may be opened or closed. Further, the gas introduction step and the gas discharge step according to the second embodiment are performed with the gate valve 4 closed, as in the first embodiment.

In the gas discharge step, an internal pressure of the preliminary chamber 3 is preferably in a vacuum state. For example, in the gas discharge step, when an internal pressure of the preliminary chamber 3 becomes 1/10 of the atmospheric pressure, the concentration of the corrosive gas in the preliminary chamber 3 also becomes 1/10. When this gas discharge step is performed twice, the concentration of the corrosive gas in the preliminary chamber 3 is 1/100. As described above, the concentration of the corrosive gas decreases as the cycle is repeated.

According to the production method for the glass preform G of the present embodiment, the gas introduction step and the gas discharge step are alternately performed at least once. Therefore, since no gas is introduced during the gas discharge step, a complicated control is not required for the gas introduction step and the gas discharge step. In addition, a degree of freedom is improved in locations where the preliminary chamber gas introduction port 31 and the preliminary chamber gas discharge port 32 are formed.

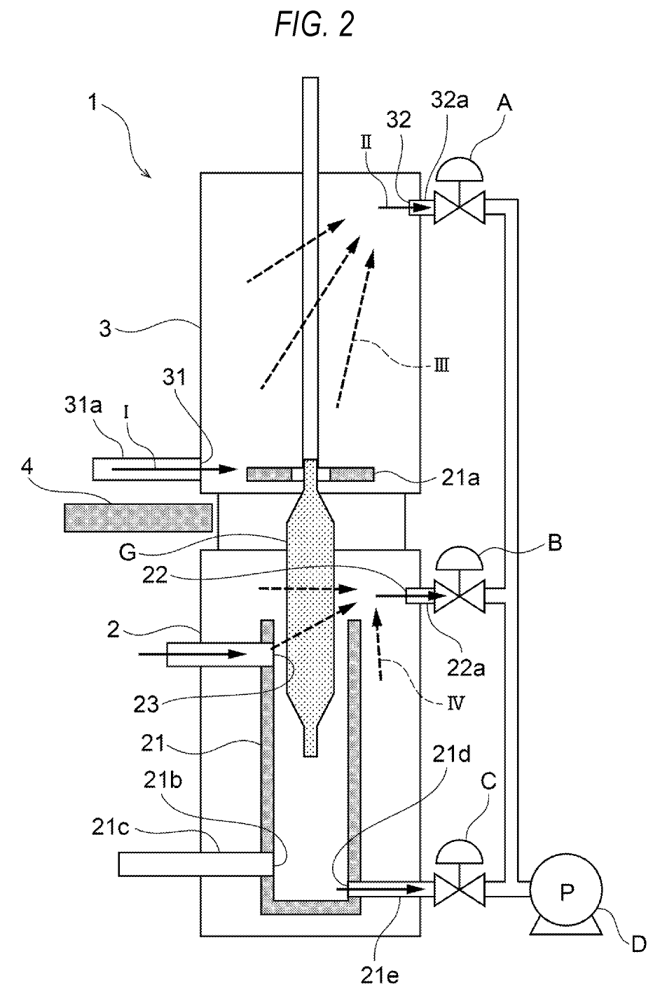

Next, a production method for the glass preform G according to the third embodiment will be described. FIG. 2 illustrates the production apparatus 1 for the glass preform G and the production method therefor according to the third embodiment. The production apparatus 1 according to the third embodiment further includes a main chamber gas introduction port 23. The main chamber gas introduction port 23 is formed so that the inert gas can be introduced into the main chamber 2, for example, into the furnace core tube 21.

In the production method for the glass preform G according to the third embodiment, the production step is not different from the production step of the first embodiment, and thus the description thereof will be omitted.

The gas introduction step and the gas discharge step according to the third embodiment are performed in a state in which the gate valve 4 is open. The gas introduction step and the gas discharge step may be performed not only when the glass preform G is accommodated in the preliminary chamber 3 but also, for example, when the glass preform G is moved from the main chamber 2 to the preliminary chamber 3 after the end of the production step. The gas introduction step and the gas discharge step may be performed alternately or simultaneously. In the third embodiment, the gas introduction step and the gas discharge step are performed simultaneously.

The gas introduction step according to the third embodiment includes introducing the gas from the preliminary chamber gas introduction port 31 formed in the preliminary chamber 3. It is desirable that the inert gas is introduced not only from the preliminary chamber gas introduction port 31 but also from the main chamber gas introduction port 23.

The gas discharge step includes not only discharging the gas in the preliminary chamber 3 from the preliminary chamber gas discharge port 32 but also discharging the gas in the main chamber 2 from the main chamber discharge port 22. In this case, in the gas introduction step and the gas discharge step, the first flow rate regulator A and the second flow rate regulator B are always opened. In the present embodiment, in the gas discharge step, the gas in the furnace core tube 21 is discharged through the furnace core tube discharge pipe 21e. In this case, in the gas introduction step and the gas discharge step, in addition to the first flow rate regulator A and the second flow rate regulator B, the third flow rate regulator C is also always opened.

In the gas introduction step, the inert gas is introduced from the preliminary chamber gas introduction port 31, and in the gas discharge step, the gas is discharged from the preliminary chamber gas discharge port 32, which are simultaneously performed. Therefore, similarly to the first embodiment, the flow of air from the preliminary chamber gas introduction port 31 toward the preliminary chamber gas discharge port 32 is formed inside the preliminary chamber 3 as indicated by the dashed arrow III. Therefore, the air inside the preliminary chamber 3 is easily discharged from the preliminary chamber gas discharge port 32.

In the gas introduction step, the inert gas is introduced from the main chamber gas introduction port 23, and in the gas discharge step, the gas is discharged from the main chamber discharge port 22, which are simultaneously performed. Therefore, the flow of air in which the gas flows from the main chamber gas introduction port 23 toward the main chamber discharge port 22 is formed inside the main chamber 2 as indicated by a dashed arrow IV. Accordingly, the corrosive gas inside the main chamber 2 is also easily discharged together with the inert gas, and the concentration of the corrosive gas in the main chamber 2 is reduced, so that an amount of the corrosive gas flowing from the main chamber 2 into the preliminary chamber 3 is also reduced, and the concentration of the corrosive gas in the preliminary chamber 3 is reduced.

When the gas introduction step and the gas discharge step are alternately performed, and when the inert gas is introduced from the preliminary chamber gas introduction port 31 and the main chamber gas introduction port 23, first, the first flow rate regulator A, the second flow rate regulator B, and the third flow rate regulator C are closed. Next, when the introduction of the inert gas from the preliminary chamber gas introduction port 31 and the main chamber gas introduction port 23 is stopped, the first flow rate regulator A, the second flow rate regulator B, and the third flow rate regulator C are opened, and the discharge of the gas is started. When the discharge of the gas ends and the inert gas is introduced again, the first flow rate regulator A, the second flow rate regulator B, and the third flow rate regulator C are closed.

According to the production method for the glass preform G of the present embodiment, since the main chamber 2 and the preliminary chamber 3 are not separated by the gate valve 4, the corrosive gas is less likely to remain in the main chamber 2. As a result, even when the gate valve 4 needs to be opened during work, the concentration of the corrosive gas in the preliminary chamber 3 is maintained low.

According to the production method for the glass preform G of the present embodiment, since the gas is discharged from both the main chamber 2 and the preliminary chamber 3 in a state in which the main chamber 2 and the preliminary chamber 3 are not separated by the gate valve 4, the concentration of the corrosive gas in the main chamber 2 and the preliminary chamber 3 can be reduced.

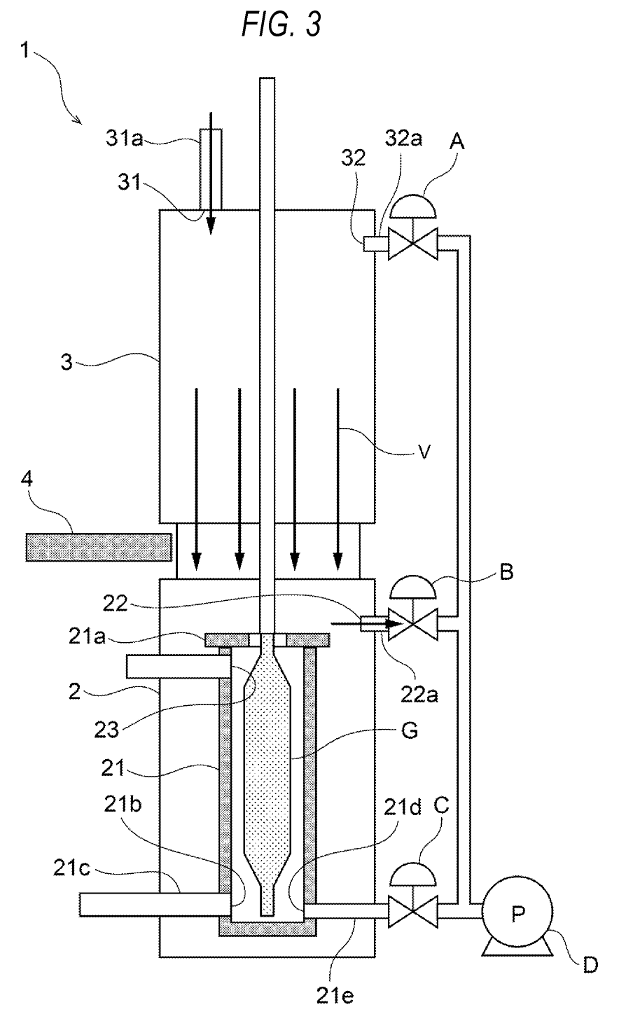

FIG. 3 illustrates the production apparatus 1 for the glass preform G and the production method therefor according to the fourth embodiment. In the production apparatus 1 for the glass preform G according to the fourth embodiment, the preliminary chamber gas introduction port 31 is formed in the upper portion of the preliminary chamber 3.

In the production method for the glass preform G according to the fourth embodiment, the production step is not different from the production step of the first embodiment, and thus the description thereof will be omitted.

The gas introduction step and the gas discharge step according to the fourth embodiment are performed in a state in which the gate valve 4 is open as in the third embodiment. The gas introduction step and the gas discharge step according to the fourth embodiment may be performed, for example, not only when the glass preform G is accommodated in the preliminary chamber 3 but also during the production step or when the glass preform G is moved from the main chamber 2 to the preliminary chamber 3 after the production step ends. The gas introduction step and the gas discharge step according to the fourth embodiment are performed simultaneously.

The gas introduction step according to the fourth embodiment includes introducing the inert gas from the preliminary chamber gas introduction port 31 formed in the preliminary chamber 3.

The gas discharge step according to the fourth embodiment is a step of discharging the gas in the main chamber 2 from the main chamber discharge port 22. In this case, when the gas introduction step and the gas discharge step are started, the first flow rate regulator A and the third flow rate regulator C are closed, the second flow rate regulator B is opened, and the second flow rate regulator B remains opened while the gas introduction step and the gas discharge step are performed.

In this case, since the gas is introduced into the preliminary chamber 3 and discharged from the main chamber 2, the gas flows from the preliminary chamber 3 toward the main chamber 2 (an arrow V). Therefore, the corrosive gas introduced into the furnace core tube 21 is less likely to flow from the main chamber 2 to the preliminary chamber 3.

According to the production method for the glass preform G of the present embodiment, a gas flow is formed in which the gas introduced into the preliminary chamber 3 in the gas introduction step flows into the main chamber 2 and is discharged in the gas discharge step. This makes it difficult for the corrosive gas to flow from the main chamber 2 to the preliminary chamber 3. Accordingly, the concentration of the corrosive gas in the preliminary chamber 3 can be reduced.

Although the present disclosure has been described in detail with reference to the specific embodiments, it is apparent to those skilled in the art that various changes and modifications can be made without departing from the spirit and scope of the present disclosure. In addition, the number, positions, shapes, and the like of the constituent members described above are not limited to those in the above embodiments, and can be changed to the numbers, positions, shapes, and the like suitable for carrying out the present disclosure.

For example, the arrangement of the main chamber 2 and the preliminary chamber 3 is not limited to the example of the present embodiment. The arrangement of the introduction port and the discharge port formed in the main chamber 2 or the preliminary chamber 3 is not limited to the example of the present embodiment.

What is claimed is:

1. A production method for a glass preform in a production apparatus,
the production apparatus including:
a main chamber configured to produce the glass preform in a state where a glass fine particle deposit is accommodated in the main chamber; and
a preliminary chamber communicating with the main chamber, the preliminary chamber being formed such that the glass fine particle deposit and the glass preform are allowed to be put in and taken out,
wherein a furnace core tube is accommodated inside the main chamber, the furnace core tube being configured to produce the glass preform in a state where the glass fine particle deposit is accommodated in the furnace core tube,
the production method comprising:
a production step of producing the glass preform by consolidating the glass fine particle deposit in the furnace core tube while introducing corrosive gas into the furnace core tube;
a gas introduction step of introducing gas into the preliminary chamber after the production step; and
a gas discharge step of discharging gas from at least one of the preliminary chamber and the main chamber after the production step,
wherein the gas introduction step is started before end of the gas discharge step.

2. The production method for a glass preform according to claim 1,
wherein the gas discharge step is a step of discharging gas from the preliminary chamber.

3. The production method for a glass preform according to claim 2,
wherein the gas introduction step and the gas discharge step are alternately performed at least once.

4. The production method for a glass preform according to claim 2,
wherein the gas introduction step and the gas discharge step are performed simultaneously.

5. The production method for a glass preform according to claim 1,
wherein the production apparatus includes a gate valve configured to separate the main chamber and the preliminary chamber, and
the gas introduction step and the gas discharge step are performed in a state where the main chamber and the preliminary chamber are separated from each other by the gate valve.

6. The production method for a glass preform according to claim 1,
wherein the production apparatus includes a gate valve configured to separate the main chamber and the preliminary chamber, and
the gas introduction step and the gas discharge step are performed in a state where the main chamber and the preliminary chamber communicate with each other by the gate valve.

7. The production method for a glass preform according to claim 6,
wherein the gas is discharged from the preliminary chamber and the main chamber in the gas discharge step.

8. The production method for a glass preform according to claim 6,
wherein the gas introduction step and the gas discharge step are performed simultaneously, and
the gas discharge step is a step of discharging gas from the main chamber.

9. The production method for a glass preform according to claim 1,
wherein the gas introduced in the gas introduction step is inert gas.

10. A production apparatus for a glass preform, the production apparatus comprising:
a main chamber configured to produce the glass preform in a state where a glass fine particle deposit is accommodated in the main chamber;
a preliminary chamber communicating with the main chamber, the preliminary chamber being formed such that the glass fine particle deposit and the glass preform are allowed to be put in and taken out; and
a furnace core tube accommodated inside the main chamber, and the furnace core tube being configured to produce the glass preform in a state where the glass fine particle deposit is accommodated in the furnace core tube,
wherein a corrosive gas introduction port for introducing corrosive gas during consolidating of the glass fine particle deposit is formed in the furnace core tube,
a gas introduction port for introducing inert gas after production of the glass preform is formed in the preliminary chamber, and
a gas discharge port for discharging gas after production of the glass preform is formed in either the main chamber or the preliminary chamber.
